(19) United States
(12) Patent Application Publication
(10) Pub. No.: US 2020/0240427 A1
(43) Pub. Date: Jul. 30, 2020

(54) GAS TURBINE ENGINE AND AIRCRAFT WITH A GAS TURBINE ENGINE

(71) Applicant: Rolls-Royce Deutschland Ltd & Co KG, Blankenfelde-Mahlow (DE)

(72) Inventor: Roy TEUBER, Hartmannsdorf (DE)

(21) Appl. No.: 16/712,384

(22) Filed: Dec. 12, 2019

(30) Foreign Application Priority Data
Dec. 17, 2018 (DE) 10 2018 132 544.4

(51) Int. Cl. F04D 29/10; F01D 25/16; F04D 29/056

(52) U.S. Cl. CPC F04D 29/104; F01D 25/16; F05D 2220/32; F05D 2240/55; F05D 2240/50; F04D 29/056

(57) ABSTRACT

A gas turbine engine includes coaxially arranged shafts mounted in a bearing chamber. An interior of the bearing chamber is sealed via sealing units which can be loaded with blocking air on sides facing away from the interior. The pressure of the blocking air is in each case greater than the pressure in the bearing chamber. An intermediate shaft sealing unit is provided radially between the shafts, and can be loaded with the blocking air on both sides in the axial direction, and seals a region between the shafts, adjoining the bearing chamber, from a further region between the shafts. Regions carrying blocking air, in which different pressure levels prevail during operation, are connected together for immediate pressure balance via openings on the side of the intermediate shaft sealing unit facing the sealing units, and on the side of the intermediate shaft unit facing away from the sealing units.

This application claims priority to German Patent Application DE102018132544.4 filed Dec. 17, 2018, the entirety of which is incorporated by reference herein.

The present disclosure relates to a gas turbine engine and to an aircraft with a gas turbine engine.

Gas turbine engines for aircraft are known in practice with a bearing chamber in the region of a turbine device, in the region of which a low-pressure shaft and a high-pressure shaft are mounted by means of bearings. During operation of the gas turbine engine, an air- oil mixture forms in the bearing chamber due to the mixing of air with oil provided for lubrication of the bearings. In order to prevent the escape of the air-oil mixture from the bearing chamber, the bearing chamber is loaded with so-called blocking air from the outside during operation of the gas turbine engine. For this, a blocking chamber is provided upstream and downstream of the bearing chamber, and is separated from the bearing chamber by a respective seal. The blocking air is supplied to the blocking chambers and conducted into the bearing chamber via the respective labyrinth seal.

Solutions are also known in which a purge chamber is arranged on the sides of the blocking chambers facing away from the bearing chamber. The purge chambers are each separated from the respective blocking chamber via a labyrinth seal, and are also loaded with blocking air coming from the blocking chambers. The purge chambers are actively connected to a core flow channel or main gas channel via a purge device so that, during operation of the gas turbine engine, air from the purge chambers can be discharged into the core flow channel. In the case where the air-oil mixture from the bearing chamber passes into the blocking chambers, the mixture is discharged into the core flow channel via the purge chambers and the purge devices. The purge devices thus prevent the air-oil mixture from entering a rotor chamber in which rotors are arranged. Since high operating temperatures prevail in the rotor chamber during operation of the gas turbine engine, it is possible that the air-oil mixture entering the rotor chamber could ignite, causing irreversible damage.

It is furthermore known that blocking air from the different pressure regions of the gas turbine engine is conducted into the blocking chambers. During unfavourable operating states of such gas turbine engines, it is possible for pressure differences to build up between the separate regions carrying blocking air. The pressure differences adversely affect the supply of blocking air from the blocking chambers into the bearing chambers via the sealing units, and promote an escape of the air-oil mixture from the bearing chambers in the direction of the blocking chambers, which is disadvantageous for the reasons described in more detail above.

To compensate for such pressure differences, it is known to connect together regions of a gas turbine engine carrying blocking air, in which different pressure levels prevail during operation of the gas turbine engine, for pressure balance on the side of a sealing unit, facing the labyrinth seals of the bearing chamber, of an intermediate shaft between the high-pressure shaft and the low-pressure shaft.

The disadvantage here however is that the latter measure again may lead to a pressure fall over the intermediate shaft sealing unit, which promotes an oil escape from the bearing chambers.

A gas turbine engine and an aircraft with a gas turbine engine are proposed, in which an oil escape from a bearing chamber is avoided in a structurally simple fashion.

This object is achieved by a gas turbine engine having the features of Patent claims 1 and 7 respectively.

According to a first aspect, a gas turbine engine is provided with at least two coaxially arranged shafts. The shafts are mounted rotatably via bearings which are arranged in at least one bearing chamber. An interior of the bearing chamber is sealed via sealing units. The sealing units can be loaded with blocking air on their sides facing away from the interior of the bearing chamber.

The pressure of the blocking air for sealing the bearing chambers during operation of the gas turbine engine is in each case greater than the pressure in the interior of the bearing chamber. At least one intermediate shaft sealing unit is provided radially between the shafts and can be loaded with the blocking air of the bearing chambers on both sides in the axial direction. Furthermore, the intermediate shaft sealing unit seals a region between the shafts, adjoining the bearing chamber, from a further region between the shafts. Regions carrying blocking air and in which different pressure levels prevail during operation of the gas turbine engine, are connected together for pressure balance on the side of the intermediate shaft sealing unit facing the sealing units. In addition, the regions carrying blocking air are also actively connected with each other for immediate pressure balance via openings on the side of the intermediate shaft sealing unit facing away from the sealing units.

Here, the term “immediate pressure balance” means a pressure balance between the regions carrying blocking air without a temporal delay.

By means of the gas turbine engine, faults induced by the air system, which adversely affect a seal of the bearing chamber because of a pressure fall between regions carrying blocking air, are easily avoided. The gas turbine engine according to the present disclosure balances a pressure fall between the regions carrying blocking air with little structural complexity, and avoids the escape of oil from the bearing chamber into the engine core.

Furthermore, in a gas turbine engine according to the present disclosure, a requirement that an oil leak from a bearing chamber must not cause irreversible damage to a gas turbine engine, is easily fulfilled. Previously, to minimize such a risk, a great structural complexity was required in order to prevent an oil escape from a bearing chamber. This structural complexity increases the component weight, specific fuel consumption and production costs of a gas turbine engine.

In addition, the gas turbine engine according to the present disclosure, in comparison with known gas turbine engine systems in which an oil escape from a bearing chamber and the resulting risks cannot be reduced or eliminated even by structural measures, can be operated with less complex control and regulation systems. This is because of the fact that the known gas turbine engines must be equipped with so-called detection systems in order to be able to shut down a gas turbine engine before damage occurs in the event of an oil fire. The gas turbine engine according to the present disclosure can be operated without such a detection system.

Furthermore, the gas turbine engine according to the present disclosure is characterized by a low oil consumption, despite the fact that the sealing performance of sealing systems of gas turbine engines diminishes as the operating time increases.

If the openings which connect the regions carrying blocking air have flow cross-sections in a range from 25 mm² to 500 mm², an immediate pressure balance between the regions carrying blocking air on the side of the intermediate shaft sealing unit facing the sealing units, and on the side of the intermediate shaft facing away from the sealing units, can be easily guaranteed by structural measures.

Here it is possible that the flow cross-sections of the openings may have flow cross-sections even larger than 500 mm² depending on the application concerned.

According to a further aspect, the regions carrying blocking air are each actively connected with a compressor region of the gas turbine engine according to the present disclosure, in which the pressures differ from each other. This in turn, in a simple fashion, offers the possibility of operating the gas turbine engine according to the present disclosure with high efficiency, since the blocking air is provided amongst others from a compressor region which has a low pressure level, and therefore only low power losses occur due to the extraction of the blocking air.

If the regions carrying blocking air are actively connected together via drainage openings, then with little structural complexity, oil accumulations in cavities inside the gas turbine engine are avoided.

According to a further aspect, the regions carrying blocking air are each sealed, on the sides of the sealing units facing away from the interior of the bearing chamber, via at least one respective sealing unit, against a hot air outlet in which the pressure during operation of the gas turbine engine is lower than in the regions carrying blocking air. This again guarantees that any air-oil mixture emerging from the bearing chamber can be conducted into the hot air outlet together with the escaping blocking air via the sealing unit.

According to a further aspect, the regions carrying blocking air are delimited at least in regions by the shafts. Thus the gas turbine engine according to the present disclosure is characterized by a low number of parts.

The present disclosure also concerns an aircraft which is equipped with a gas turbine engine as described in more detail above.

It is self-evident to a person skilled in the art that a feature or parameter described in relation to any one of the above aspects may be applied to any other aspect, unless they are mutually exclusive. Furthermore, any feature or any parameter described here may be applied to any aspect and/or combined with any other feature or parameter described here, unless they are mutually exclusive.

Exemplary embodiments are now described with reference to the figures, wherein for the sake of clarity, in the description of the various exemplary embodiments, the same reference signs are used for components with the same function and structure.

In the figures:

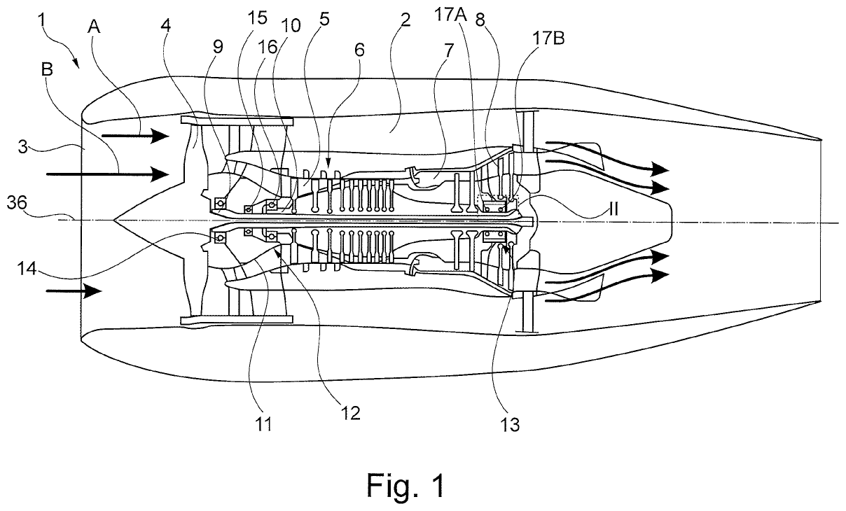

FIG. 1 shows a longitudinal sectional view of a gas turbine engine;

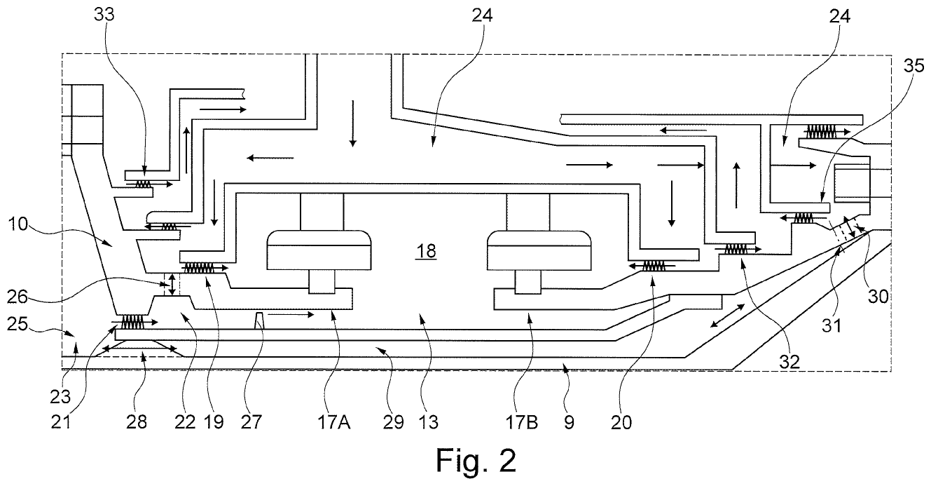

FIG. 2 shows an enlarged depiction of a region II, marked in more detail in FIG. 1, of the gas turbine engine according to FIG. 1, and

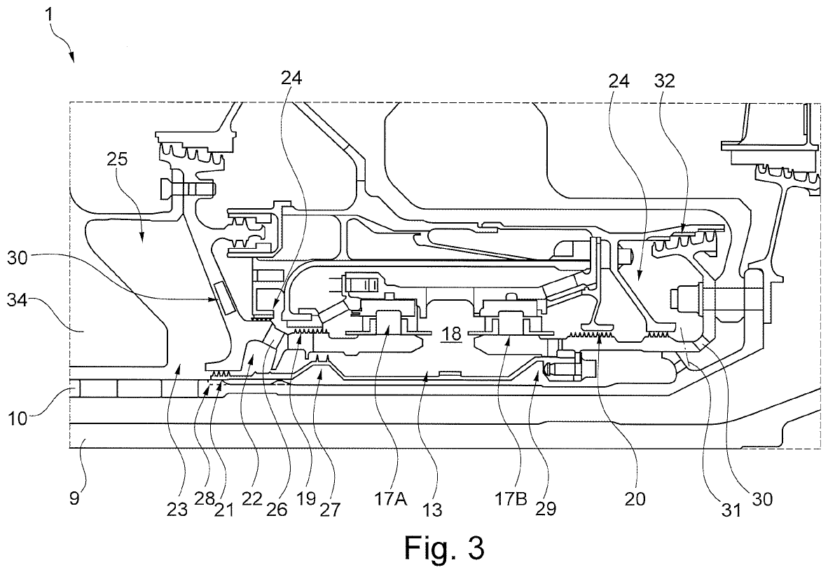

FIG. 3 shows a depiction corresponding to FIG. 2 of the region II of a further exemplary embodiment of the gas turbine engine having three shafts.

FIG. 1 shows a gas turbine engine 1, preferably for an aircraft, in a diagrammatic longitudinal sectional view. The gas turbine engine 1 is formed with a bypass channel 2 and an inlet region 3, wherein a fan 4 adjoins the inlet region 3 downstream in the known fashion. Again downstream of the fan 4, the fluid flow in the gas turbine engine 1 is divided into a bypass flow A and a core flow B. The bypass flow A flows through the bypass channel 2, while the core flow B flows into an engine core 5. The engine core 5 is in turn designed in the known fashion with a compressor device 6, a burner 7 and a turbine device 8.

The gas turbine engine 1 in the present case has two shafts, a first shaft 9 representing a low-pressure shaft, and a second shaft 10 representing a high-pressure shaft. The low-pressure shaft 9 and the high-pressure shaft 10 are each mounted so as to be rotatable about a central axis 36. The low-pressure shaft 9 is connected rotationally fixedly to the fan 4, and during operation of the gas turbine engine 1 rotates about the central axis 36 with a lower rotation speed than the high-pressure shaft 10. For mounting the shafts 9, 10 together and relative to a casing device 11 of the gas turbine engine 1, several bearings 14, 15, 16, 17A, 17B are provided. The bearings 14, 15, 16, designed as roller bearings, are in the present case arranged in a bearing chamber 12 at the front in the axial direction of the gas turbine engine 1, while the bearings 17A and 17B, also designed as roller bearings, are mounted in a bearing chamber 13 at the rear in the axial direction of the gas turbine engine 1.

FIG. 2 shows a region II, marked in more detail in FIG. 1, of a further embodiment of the gas turbine engine 1 which comprises the rear bearing chamber 13. An interior 18 of the rear bearing chamber 13 is sealed against the environment of the bearing chamber 13 via sealing units 19, 20, 27. In the exemplary embodiment shown in FIG. 2, the sealing units 19, 20, 27 are each designed as labyrinth seals and can be loaded with blocking air on their sides facing away from the interior 18 of the rear bearing chamber 13. Alternatively, it is also possible to design the sealing units as brush or carbon seals. The pressure of the blocking air for sealing the bearing chamber 13 during operation of the gas turbine engine 1 is in each case greater than the pressure in the interior 18 of the bearing chamber 13.

In addition, at least one intermediate shaft sealing unit 21 is provided radially between the shafts 9, 10 and can be loaded with the blocking air of the bearing chamber 13 on both sides in the axial direction. Via the intermediate sealing unit 21, a region 22, between the shafts 9, 10 and adjoining the bearing chamber 13, is sealed from a further region 23 between the shafts 9, 10.

Regions 24, 25 carrying blocking air, in which different pressure levels prevail during operation of the gas turbine engine 1, are connected together for pressure balance via at least one opening 26 on the side of the intermediate shaft sealing unit 21 facing the sealing units 19, 20, 27; via this opening 26, an immediate pressure balance is possible between the regions 24 and 25 carrying blocking air. This means that the flow cross-section of the opening 26 is designed and dimensioned such that the opening 26 does not act as a choke over the entire operating range of the gas turbine engine 1, and virtually the same pressure level is always present in the regions 24 and 22 carrying blocking air.

Radially inside the intermediate shaft unit 21, the low-pressure shaft 9 is formed with at least one passage 28 via which the region 25 carrying blocking air is connected to a further region 29 carrying blocking air inside the low-pressure shaft 9.

So that, on the side of the intermediate shaft unit 21 facing away from the sealing units 19, 20 and 27, an immediate pressure balance is possible between the regions 24 and 25 carrying blocking air, the regions 24 and 25 carrying blocking air are connected via a further region 29 carrying blocking air and via an opening 30. To the same extent as the opening 26, the opening 30 is designed with a flow cross-section such that the opening 30 does not hinder an immediate pressure balance between the regions 24 and 25 carrying blocking air.

Depending on the application concerned and the pressure conditions prevailing in the regions 24 and 25 carrying blocking air, the openings 26 and 30 have flow cross-sections in a range from 25 mm² to 500 mm² or even larger.

Furthermore, the regions 24 and 25 carrying blocking air are actively connected to a compressor region of the gas turbine engine 1, again depending on the respective application. The pressures of the compressor regions may differ from each other.

In addition, regions 24 and 25 carrying blocking air may if necessary be actively connected together via so-called drainage openings 31, the opening cross-section of which is preferably between 10 mm² and 20 mm², in order to avoid undesirable oil accumulations in the regions 25 and 29 carrying blocking air.

In addition, the regions 24 and 25 carrying blocking air are each sealed, on the sides of the sealing units 19, 20 and 27 facing away from the interior 18 of the bearing chamber 12, via a sealing unit 32, 33 and 35 against a hot air outlet (hot vent) in which the pressure during operation of the gas turbine engine 1 is lower than in the regions 24 and 25 carrying blocking air.

FIG. 3 shows a depiction, corresponding to FIG. 2, of a further gas turbine engine 1 which substantially has the structure described with respect to FIG. 1 and FIG. 2, and has three shafts 9, 10 and 34.

The three shafts 9, 10 and 34 are arranged coaxially to each other, wherein the shaft 10 is arranged at least in regions radially between the inner shaft 9 and the outer shaft 34. The bearings 17A and 17B are again arranged in the rear bearing chamber 13, the interior 18 of which is sealed against the environment via the sealing units 19, 20 and 27, and which is loaded with blocking air from the outside during operation of the gas turbine engine 1.

The regions 24 and 25 carrying blocking air are connected together via openings 26 and 30 respectively on the side of the intermediate shaft sealing unit 21 facing the sealing units 19, 20 and 27 and also on the side of the intermediate shaft sealing unit 21 facing away from sealing units 19, 20 and 27, in order to guarantee an immediate pressure balance between the regions 24 and 25 carrying blocking air.

### LIST OF REFERENCE SIGNS

1 Gas turbine engine
2 Bypass flow channel
3 Inlet region
4 Fan
5 Engine core
6 Compressor device
7 Burner
8 Turbine device
9 Low-pressure shaft
10 High-pressure shaft
11 Housing device
12 Front bearing chamber
13 Rear bearing chamber
14 Bearing
15 Bearing
16 Bearing
17A, 17B Bearing
18 Interior of front bearing chamber
19 Sealing unit
20 Sealing unit
21 Intermediate shaft sealing unit
22 Region
23 Further region
24, 25 Region carrying blocking air
26 Opening
27 Sealing unit
28 Passage
29 Further region carrying blocking air
30 Opening
31 Drainage opening
32, 33 Sealing unit
34 Shaft
36 Central shaft

1. A gas turbine engine with at least two coaxially arranged shafts,
which are mounted rotatably via bearings,
which are arranged in at least one bearing chamber,
wherein an interior of the bearing chamber is sealed via sealing units,
the sealing units can be loaded with blocking air on their sides facing away from the interior of the bearing chamber, and
the pressure of the blocking for sealing the bearing chamber in operation of the gas turbine engine is in each case greater than the pressure in the interior of the bearing chamber,
wherein at least one intermediate shaft sealing unit is provided radially between the shafts,
which can be loaded with the blocking air of the bearing chamber on both sides in the axial direction, and
which seals a region between the shafts, adjoining the bearing chamber, from a further region between the shafts,
wherein regions carrying blocking air and in which different pressure levels prevail during operation of the gas turbine engine, are connected together for pressure balance on the side of the intermediate shaft sealing unit facing the sealing units,
and wherein the regions carrying blocking air are also actively connected with each other for immediate pressure balance via openings on the side of the intermediate shaft unit facing away from the sealing units.

2. The gas turbine engine according to claim 1, wherein the openings have flow cross-sections in a range from 25 mm² to 500 mm² or greater.

3. The gas turbine engine according to claim 1, wherein the regions carrying blocking air are each actively connected to a compressor region, wherein the pressures of the compressor regions differ from each other.

4. The gas turbine engine according to claim 1, wherein regions carrying blocking air are actively connected together via drainage openings.

5. The gas turbine engine according to claim 1, wherein the regions carrying blocking air are each sealed, on the sides of the sealing units facing away from the interior of the bearing chamber, via at least one respective sealing unit against a hot air outlet in which the pressure in operation of the gas turbine engine is lower than in the regions carrying blocking air.

6. The gas turbine engine according to claim 1, wherein regions carrying blocking air are delimited by the shafts at least in regions.

7. An aircraft with a gas turbine engine according to claim 1.
